(19) United States
(12) Patent Application Publication
(10) Pub. No.: US 2015/0199915 A1
(43) Pub. Date: Jul. 16, 2015

(54) TEACHING METHOD

(71) Applicants: Tammy Lynn Myers, Mount Pleasant, WI (US); Kimberly Marie Silverstein, Caledonia, WI (US)

(72) Inventors: Tammy Lynn Myers, Mount Pleasant, WI (US); Kimberly Marie Silverstein, Caledonia, WI (US)

(21) Appl. No.: 14/153,010

(22) Filed: Jan. 11, 2014

(51) Int. Cl. G09B 17/00

(52) U.S. Cl. CPC G09B 17/003

(57) ABSTRACT

A method of teaching is provided. The method of teaching incorporates a series of sequentially timed steps. In the first step, a student is introduced into a room (Room 1) wherein the student reads the most common words used in English (or alternative) language while being physically active while upbeat music is being played. In step two, the student is moved to a second room (Room 2) wherein the student is asked to write and illustrate stories with respect to his/her personal interest. In step three, the student is moved to a third room (Room 3) wherein the student interacts with blocks, play-dough, cards and other games to create specific sounds, words, syllables, phrases and sentences. In the fourth and final step, the student moves to a fourth room (Room 4) wherein the student reviews the most common words in the English (or alternative) language which were learned during the first step. Further, in the fourth step, the student incorporates the most frequently used words into phrases and into rhymes infused with dynamic words from a team of instructors, listening to upbeat music, while being physically active.

### CROSS REFERENCE TO RELATED APPLICATION

The following application is based on and claims the priority benefit of U.S. Provisional Application Ser. No. 61/751,912 filed on Jan. 13, 2013 currently co-pending; the entire contents of which are incorporated by reference.

### BACKGROUND OF THE INVENTION

A method of teaching is provided. The method of teaching incorporates a series of sequentially timed steps. In the first step, a student is introduced into a room (Room 1) wherein the student reads the most common words used in English (or alternative) language while being physically active while upbeat music is being played. In step two, the student is moved to a second room (Room 2) wherein the student is asked to write and illustrate stories with respect to his/her personal interest. In step three, the student is moved to a third room (Room 3) wherein the student interacts with blocks, play-dough, cards and other games to create specific sounds, words, syllables, phrases and sentences. In the fourth and final step, the student moves to a fourth room (Room 4) wherein the student reviews the most common words in the English (or alternative) language which were learned during the first step. Further, in the fourth step, the student incorporates the most frequently used words into phrases and into rhymes infused with dynamic words (vocabulary associated with high interest topics used to write and illustrate stories created by students). Examples of dynamic words may include, for example: astronaut, spaceship, blastoff, asteroid, planet, atmosphere, spacesuit, alien for a story about space travel.

Teaching a student how to read has been one of the most important aspects of education and of growing up. Methods of teaching students how to read have included: 1) the phonics approach; 2) the look/say approach; 3) the language experience approach; and 4) the concept support method. In phonics, a student is first taught the alphabet. After the student masters the names and sounds of each letter in the alphabet, the student then begins to blend multiple letters together to form simple words. In the look/say approach, the student learns to recognize and read entire words instead of individual sounds learned through phonics. In the language experience approach, the student uses words he or she is familiar with. For example, the student might talk about or draw a picture of an airplane or a baseball. The teachers would then help the student learn to recognize those words. Finally, in the concept support method, a teacher provides a student with books revolving around a specific concept of interest to the student, such as an entire picture book based on goldfish.

Patents have been granted for unique teaching methods. For example, U.S. Pat. No. 6,814,579 to Bent discloses a method of teaching using vehicles as mascots for different subject areas. Each vehicle is named after a subject area and is decorated. The vehicles serve as a means to generate enthusiasm for the subject areas. Each car has it's own color combination corresponding to a given subject. Each subject area has an instructor which is knowledgeable in that subject. The instructors wear clothing colored to match the color of the vehicle named after the subject area that he/she teaches. The instructors teach the pre-planned lessons on a topic in a subject area. The pre-planned lessons also incorporate supporting information from other subject areas to the topics. The instructors drive the vehicles to sites of instruction where students are located to perform a pre-planned lesson on a topic. The sites of instruction have or utilize concepts that will be used in the pre-planned lesson. In the presentation of the lesson, an instructor uses teaching materials colored to match the color of the vehicle that he/she drives.

Further, U.S. Pat. No. 6,685,477 to Goldman discloses method and apparatus for teaching and learning reading. The apparatus comprises blocks that are removably connectable and bear various reading indicia on their faces. The reading indicia include pictures, vowels, consonants, combinations of vowels and consonants, parts of speech, and punctuation. Preferably, any selected block has only one type of reading indicia and has color-coding associated with that type of indicia. By connecting two or more blocks so that the reading indicia form an appropriate pattern or unit, students can form parts of words, words, phrases or even sentences. Different subgroups of reading indicia may be used in progression to teach and learn at different skill levels.

The present method invokes a unique classroom teaching method. It embraces proven techniques which have been specifically brought together for the first time to form a highly effective and successful teaching format for instructing students to learn to read including students that have reading difficulties. Sensory styles include auditory, visual and kinesthetic learning aids in the presence of background music while participating in high interest activities. The present methods increase competent reading fluency and comprehension through a hierarchy of phonics based tasks which are not practiced in conventional classroom situations.

Student motivation and performance improves when instruction is adapted to student learning preferences and styles (Watson, 2003). There are four variable factors associated with learning acquisition: complex cognitive, emotional, social and instructional (Lipson and Wixson, 1997). Learning styles that encompass various techniques or multiple intelligence theory (MIT) will allow students to learn through their preferred model to obtain their educational goals. Types of learning include: sensory/intuitive, visual/verbal, inductive/deductive, active/reflective, and sequential/global. A student's preference may vary between subjects and their learning environment (Watson, 2003, Gardner, 1999, Griss, 2012).

Generally, fewer than 12% of elementary age children are auditory learners (Dunn 2001) and it has been estimated that 85% of students are predominately kinesthetic learners (Lengel and Kuczala, 2010). Sight, hearing and touch (movement) contribute most to learning. However children's education is often missing kinesthetic integrated movement (Sousa, 2006). Approximately 40 percent of students across the nation cannot read at a basic level. Almost 70 percent of low-income fourth grade students cannot read at a basic level (Children's Reading Foundation). A study of learning styles by Dunn and Dunn (1992) has highlighted the need for a greater variety of multisensory activities such as kinesthetic movement and touch. It has been established that good readers prefer to learn through visual and auditory senses, while poor readers prefer tactile and kinesthetic learning (Griss, 2012).

Sequential Hierarchy of Reading Skills (SHRS) is defined as the sequential developmental order of skills needed to acquire competency in reading, reading fluency and reading comprehension. The specific developmental order is phonemic awareness, phonemic segmentation, phonemic blending, syllable awareness, syllable segmentation, syllable blending, rhyming, phrasing and fluency to include comprehension.

Repetitive, Predictable, Reciprocal and Developmental (RPRD) Multisensory is defined as activities that are auditory, visual and/or kinesthetic physical tasks which can be duplicated within short periods of time (repetitive), provide anticipated outcomes (predictable), can be explained or taught peer to peer (reciprocal) and built upon for advancement in learning (developmental). Core Initiation (CI) is defined as the point at which an individual student is motivated by high interest to begin the learning process.

The sequential hierarchy of reading skills (SHRS) is recognized to include: phonemic awareness, phonemic segmentation, phonemic blending, syllable awareness, syllable segmentation, syllable blending, rhyming, phrasing and fluency to include comprehension. The present teaching method uses the sequential hierarchy of development of reading skills and applies teaching strategies through multisensory activities that are repetitive, predictable, reciprocal and developmental (RPRD) along with the use of the student's interests as the Core Initiation (CI) of the program. The Core Initiation, as utilized in the present teaching method, refers to the starting point toward the motivation of learning to read. The present teaching method incorporates upbeat music, games, humorous activities and student driven vocabulary (dynamic words) along with basic high frequency words as the core initiation for beginning the program. In the present teaching method, high interest increases motivation. One way to increase high interest is to make the learning activities fun. By raising the value of fun to the same level of importance as the presentation of the skill being taught, the motivation to learn the skill is observed to be increased. When learning is fun, correlatively learning about learning (metacognition) is fun. When “fun” is raised to an equal level of presentation as the reading skills that are being taught, then learning becomes fun and the cognition required to continue learning developmentally is facilitated through play and not perceived as a redundant routine tasks.

SHRS+RPRD+CI (Motivation to Learn)+Fun=Facilitated Developmental Learning. The present method designated 4 different physical spaces to support the curriculum and activities for learning to read. We call these spaces “chapters”. The students move through each chapter during their 50 minute session, which meets twice per week for nine weeks. The chapters are described toward the end of this paper.

Phonetic instruction is an essential component of learning to read. Beginning reading instruction for children who lack phoneme awareness is likely to result in reading difficulty (Adams, 1990). Research indicates that early emphasis on teaching word decoding and systematic phonetic instruction on letter-to-sound correspondences, leads to higher achievement in both word recognition and spelling, especially in the early grades (Adams, 1990; Chall, 1989, 1996).

Teaching phonics is generally understood to encompass rapid recognition of text and comprehension of the text (Stahl et al., 1998). Therefore it is important to teach students how to recognize words. The present teaching method uses, in chapters 1 and 4, a curriculum based upon the one thousand most frequently used words in the English language (Fry, Kress and Fountoukidis, 2000) to facilitate rapid reading and text comprehension. Whole language advocates instruction inserts phonics for cueing to identify words while reading is partially based on Goodman (1976). However they used phonics only as an aid to getting meaning from a text and utilized it only as needed, resulting in a misconception, that partially isolated whole language teaching from phonics (Stahl et al., 1998). The present teaching method places emphasis on phonics as an essential part of reading instruction.

Phonics develops alphabetic principle that letters represent speech sounds. For students to have the awareness of the relationship between letters and corresponding sounds is a predictor of success for beginning readers (Adams, 1990). As phonological awareness develops, learning about the influence of letters (sounds) on words continues to influence the child that is learning to articulate or pronounce letters (sounds) which will transfer to more complex language development, particularly vocabulary and understanding of the world around them. Phonological awareness develops around the same time as when children commence formal reading instruction. Children learn through ‘visual cues’ known as pre-alphabetic, ‘phonetic cues’ such as initial or final sounds and reach the ‘full alphabetic stage’ when they use all letters and sounds (Ehri, 1995). Prephonemic′, or invented spellings is another approach to learning phonics and leads the over identification of consonants, where the child is using all the consonants in a word and often omitting vowels (Gillet and Temple, 1990). Phonological awareness is the first stage for children to learn to read and is the foundation for development of the other primary reading skills such as the alphabetic principle, word recognition and invented spelling (Stanovich, 1991). All the tasks described by Stahl et al., (1998) are implemented by the present teaching method. These include rhyming, word to word matching tasks, sound to word matching tasks, initial or final sounds, segmentation, blending and deletion and manipulation. Phonemic manipulation and segmentation provide strong predictions of beginning reading acquisition (Adams, 1990).

In contemporary phonics there are three approaches: spelling based, analogy-based and embedded phonics approaches. Based upon the skill level and the CI of the student, the present teaching method incorporates all three approaches throughout the four chapters of the program. They are all described as components of larger reading instruction programs (Stahl et al., 1998).

Spelling based approaches include; word study, making words and metaphonics. Word study involves sorting words and word patterns according to common orthographic features (Templeton and Bear, 1992). Making words requires the compilation of words from letters on letter cards or word blocks (Hall and Cunningham, 1996). In metaphonics, reading and spelling are taught through social interaction and group problem solving, that stresses articulation of words as a key to learning sounds. Vowels are used as glue letters and students make words by adding consonants to vowels (Calfee, 1988, Stahl et al., 1998).

Analogy based approaches teach students to use new vocabulary based upon previously known order of letters and sound sequences or the contextual relationship of word meanings They are used after children recognize initial sound cues (Cunningham, 1995), and it has been suggested that children can use analogical relationships of words prior to using phonological analysis to read words (Bruck and Treiman, 1992). Analogies need to be taught in conjunction with other decoding approaches (Stahl et al., 1998).

Embedded phonics approaches are based on reading and re-reading of books of the student's choice in order to develop fluency (Clay, 1993). Visual, structural and meaning cueing systems are used to recognize words in context (Goodman (1976).

Comprehension and Developmental Learning:

A story grammar approach to obtaining comprehension and fluency is used in Chapter two, with the additional kinesthetic stimulation of writing and illustrating their own story on iPads, allowing the student to further personalize the story and make an emotional connection. Without a profound sense of emotional connection or interest, information can easily be forgotten (Oberparleiter, 2004). The story memory functions on the organization of incoming information, but also depends on mental operations and cognitive structures already acquired by the individual. There is a strong correlation between prior knowledge and reading comprehension ability (Fielding and Pearson, 1994). Therefore schemata structure is based on the presence of new information modifying the old structures (Stein, 1978). Schemata may be acquired through hearing or reading a variety of different stories and by the accumulation of knowledge regarding human social interactions. Children are likely to understand sequences of physical events as well as personal events, providing the sequence matches previous knowledge structures that they have acquired.

Research supports the claim that the search for meaning occurs through patterning (Caine and Caine, 1994, Howard 2002, King, 1997 and Smilkstein, 1993). Patterning refers to the meaningful organization and categorization of information (Nummela and Rosegren, 1986). The brain is designed to search for and integrate new information into existing structures and actively resists “meaningless” patterns (Caine and Caine, 1994).

Good readers read familiar words accurately and rapidly. They remember spelling patterns shared by known words and use this knowledge in decoding unknown words (Gaskins et al 1996). Good readers connect past experiences with the text, analyzing and interpreting alternative responses (Applegate et al., 2002). Children possess morphological rules, preferring the most general and regular rules for the formation of plural words and they use little derivation (Berko, 1958).

Several categories occur within a story structure, each referring to a specific type of information and serving a different function in the story. Therefore a story structure can be described in terms of a tree diagram (Mandler and Johnston, 1977). The story structure is composed as; setting, initiating event, internal response, attempt, consequence and reaction. Those most easily recalled by the student are the setting, initiating event and the consequence. Connecting categories are essential to the formation of a story (Stein, 1978). The present teaching method uses story setting structures including; setting, beginning, middle, end, includes 3 events and the consequence which may be a problem/goal/lesson summarized after completion of the story. Therefore, in Chapter 2, story mapping, spelling, grammar, character development, sequencing and fluency for increased comprehension are addressed. Children as young as six make very few errors in recalling the order of stories corresponding to the structured categories (Mandler and Johnston, 1977). Also pre-school children of four to five years old experience little difficulty ordering the events in a story, providing that the story corresponded to the expected sequence (Stein and Garfin, 1977). However younger children may be less familiar with deviant structure (Mandler and DeForrest, 1977), in the present teaching method the younger children are provided for in the Bookworm class structure.

Fluency:

A child's ability to read can be determined by their level of automaticity in reading sight words Stanovich et al., (1981) and are based on the Automaticity Theory (AT) (La Berge and Samuels, 1974, Samuels and Flor, 1997) and the Verbal Efficiency Theory (VET) (Perfetti, 1985, 1999). La Berge and Samuels (1974) argue that reading fluency develops because lower level processes, such as letter and word recognition, become automated and free cognitive capacity for higher understanding. For some children it is easy to acquire strategies for decoding words (Leslie and Allen, 1999). However, many at-risk children are not exposed to opportunities for reading activities that would promote the development of automatic decoding skills (Adams, 1990). Due to lack of decoding skills, reading becomes a difficult and frustrating task, decreasing the desire to read, resulting in school failure (Stanovich, 1986). The most effective way for students to develop such automatic word recognition is through extensive exposure to print (Adams, 1990, Samuels, 1979, Stanovich, 1984). This leads to familiarity with the recognition of words with increased accuracy and automaticity, permitting readers to focus on text meaning rather than simply on the words. Intervention programs have included systematic word study, imitation of individual phonemes, a one on one tutoring program with emphasizes on comprehension and metacognition, and reading recovery with scaffolding and multiple cueing systems (Hiebert et al., 1992, Taylor et al., 1992, Slavin et al., 1990, Center et al., 1995). Each substantially successful reading program contains a component of oral reading of connected text (Leslie and Allen, 1999). However these methods leave further room for improvement (Leslie and Allen, 1999).

Oral Reading Fluency:

Emergent Literacy is when a child develops phoneme awareness, print concepts, letter knowledge and knowledge of the language. This is the first stage of the six stage model described by Chall (1983). Emergent Literacy is then followed by decoding, fluency, learning the new by extracting from text, assimilating multiple viewpoints from different texts and finally gaining a world view, leading to an ability to extract, weigh and add information to and from text.

Reading aloud has been shown to improve comprehension and helps focus attention when readers are tired or bored. It helps automatic reading to succeed by drowning out distractions (Bereiter and Bird, 1985, Ericsson, 1988). Oral reading fluency can be used as an indicator of overall reading competency (Adams, 1990). Performance levels can be compared between individuals and they can track the development of reading competence within an individual (Fuchs et al., 2001). Oral reading fluency is also a direct measure of phonological segmentation and rapid word recognition as invoked by LaBerge and Samuels' (1974). The present teaching method practices oral fluency across all four chapters from recitation of sight words, application of sight words into phrases and rhymes and reading their story to their peers from the iPad.

Kinesthetics:

Kinesthetic movement is a proven technique for aiding the decoding of language and is part of a multisensory approach. It enhances vocabulary and language development (Gaskins et al., 1998). It also helps students to more easily retain and recall information (Lengel and Kuczala, 2010). Mental exercise fuels the brain with oxygen and feeds it neurotropins to enhance growth and provide greater connection between neurons. Dopamine is the chemical neurotransmitter most closely associated with attention, memory storage, and comprehension and processing of new information. Dopamine release is increased in brain centers associated with learning and memory in response to rewards and positive experiences. The brain releases more dopamine into these learning circuits when the individuals are playing, laughing, exercising, and receiving acknowledgement for achievement (Salamone and Correa, 2002). Studies of how the brain functions have determined that emotions drive learning and support memory (Jensen, 1998). Children who grow up in environments that are stimulating will produce additional neural connections for development in the brain (Bruer, 1991). Attention spans of kindergarten students may range from 15 to 20 minutes (Schmitt, 1999). Movement is also great for refocusing attention and makes the learning process more efficient. The ultimate goal is for students to develop the ability to self-regulate and manage their attention spans or learning state. Manipulation of student's movement has the most influence of a student's learning states (Jensen, 2000). Kinesthetic movement is incorporated into the present teaching method across chapters, using gross (jumping, dancing, hopscotch and basketball, etc.) and fine (typing, writing, drawing, etc.) motor movements to increase memory, comprehension and create positive associations for newly acquired reading skills.

There are six specific purposes for movement:

Purpose 1. Movement improves neural connections, thereby heightening cognitive abilities. The two hemispheres of the brain can be stimulated to work together by crossing the midline, referring to moving the arms and/or legs across the body from one side to the other. The activity assists in energy and blood flow, decreasing muscle tension and stimulating and focusing the brain to improve concentration. Both hemispheres of the brain are used when learning how to read, write, comprehend information and seek solutions to problems. (Dennison and Dennison, 1988, Hannaford, 1995 and Promislow 1999).

Purpose 2. Provide Brain Breaks; Increases oxygen intake such as deep breaths which prevent confusion, concentration and memory problems (Blaydes Madigan, 1999).

Purpose 3. Support exercise and fitness; classroom performance correlates to the student's level of good physical health (Ratey, 2008). Exercise energizes and reduces stress and improves mental and emotional well-being. Movement meets basic needs; survival, belonging, power, freedom and fun (Glasser, 1998). Movement-orientated classroom activities build belonging, trust and a sense of fun.

Purpose 4. Movement activities develop bonding between students, providing a fun safe environment.

Purpose 5. Connect new cognitive skills to movement for easier recollection, retention and application. Recall and retention of newly acquired information is increased when paired with movement (Hannaford, 1995).

Purpose 6. Increases the efficiency of application of new concepts. When new concepts are taught with movement it will students efficiently recall and apply the new knowledge in meaningful ways (Blaydes Madigan, 1999).

Music and Learning:

Music is an influential tool without the use of words. Steady, up-beat music has a positive influence on learning and memory. “It is the doing, in addition to the listening, that offers the greatest positive benefit in all aspects of learning, especially in music” (Wilcox, 1999). Learning is strongly influenced by emotion (Jensen, 1998) and listening to music can influence a positive attitude. “Children will move naturally to almost any musical selection. The seeds of listening encourage intuitive, creative responses to music experiences will affect children's listening, singing, communication, and reading skills throughout their lives” (Wilcox, 1999).

Music can also assist with memorization. When items to be memorized are set to music, children remember them more readily. Music helps children and adults stay alert and perform better in all areas of the academic curriculum. (Sawyers & Hutson-Brandhagen, 2004, Weikart, 1998).

It “has the ability to relax, give pleasure, irritate and deafen us, stimulate, excite, make us feel happier or sadder.” Physiological changes are associated with mood changes. Physical changes include an increase or decrease in heartbeats, and increase or decrease in blood pressure, and an increase and decrease in respiration rate (Federico, 2002).

Conclusion:

The present method for teaching reading and reading comprehension utilizes the most effective teaching strategies incorporated with facilitated developmental learning. It is a uniquely designed teaching method based upon proven, relevant and substantiated research incorporating SHRS (sequential hierarchy of reading skills), RPRD multisensory activities that are repetitive, predictable, reciprocal and developmental (RPRD) along with the use of the student's interests as the Core Initiation (CI) of the program. Incorporating a sequential hierarchy of reading skills, multisensory activities, with high interest topics or tasks is supported by a review of literature, yet has not been incorporated into the primary practice of teaching reading and reading comprehension.

However, the previously identified patents fail to provide a teaching method which is easy to use and highly effective as in the present method. Further, these previous patents fail to disclose a teaching method in which students sequentially move through isolated rooms and wherein students perform detailed tasks in each of the rooms. A need therefore exists for an improved teaching method.

### SUMMARY OF THE INVENTION

A method of teaching is provided. The method of teaching incorporates a series of sequentially timed steps. In the first step, a student is introduced into a room (Room 1) wherein the student reads the most common words used in English (or alternative) language while being physically active while upbeat music is being played. In step two, the student is moved to a second room (Room 2) wherein the student is asked to write and illustrate stories with respect to his/her personal interest. In step three, the student is moved to a third room (Room 3) wherein the student interacts with blocks, play-dough, cards and other games to create specific sounds, words, syllables, phrases and sentences. In the fourth and final step, the student moves to a fourth room (Room 4) wherein the student reviews the most common words in the English (or alternative) language which were learned during the first step. Further, in the fourth step, the student incorporates the most frequently used words into phrases and into rhymes infused with dynamic words from a team of instructors, listening to upbeat music, while being physically active.

An advantage of the present teaching method is that the present teaching method allows a student to learn to read in a quick and efficient manner.

Another advantage of the present teaching method is that the present teaching method may be used in a building with limited space.

Yet another advantage of the present teaching method is that the present teaching method may teach students of different levels efficiently.

Still another advantage of the present teaching method is that the present teaching method incorporates physical exercise into the learning to read process.

And another advantage of the present teaching method is that the present teaching method incorporates the student's personal interests into the learning process.

Another advantage of the present teaching method is that the present teaching method is easily duplicated by multiple instructors.

Still another advantage of the present teaching method is that the present teaching method may be used on multiple students at the same time.

Yet another advantage of the present teaching method is that the present teaching method allows a student to not only learn reading skills, but also allows a student to learn computer skills.

For a more complete understanding of the above listed features and advantages of the present teaching method, reference should be made to the following detailed description of the preferred embodiments. Further, additional features and advantages of the present invention are described in, and will be apparent from, the detailed description of the preferred embodiments and from the drawings.

### DETAILED DESCRIPTION OF THE PREFERRED EMBODIMENTS

A method of teaching is provided. The method of teaching incorporates a series of sequentially timed steps. In the first step, a student is introduced into a room (Room 1) wherein the student reads the most common words used in English (or alternative) language while being physically active while upbeat music is being played. In step two, the student is moved to a second room (Room 2) wherein the student is asked to write and illustrate stories with respect to his/her personal interest. In step three, the student is moved to a third room (Room 3) wherein the student interacts with blocks, play-dough, cards and other games to create specific sounds, words, syllables, phrases and sentences. In the fourth and final step, the student moves to a fourth room (Room 4) wherein the student reviews the most common words in the English (or alternative) language which were learned during the first step. Further, in the fourth step, the student incorporates the most frequently used words into phrases and into rhymes infused with dynamic words from a team of instructors, listening to upbeat music, while being physically active.

Referring now to FIG. 1, a flow chart is provided illustrating the sequential steps of the present teaching method. More specifically, the present method involves moving students through a plurality of isolated rooms. In an embodiment, the rooms are brightly colored. Although the method is especially suitable for teaching children approximately five to twelve years of age, the method may be used for any students of any age. Preferably, each of the plurality of rooms has four to seven students participating at any single moment. Further, it is desirable that the same groups of students proceed through each room together, as a single unit, and participate in the entire program as a single unit. Although the exact duration of the program may vary, the groups of students preferably meet approximately twice a week for nine weeks.

In Room 1 (sometimes called the “video room”) a student is first asked to read some of the most frequently used words in the English language (or an alternative language if the lessons are not in English) while performing a physical activity. For example, words like “he”, “she”, “my”, and “you” and other common English words may be used in Room 1. The students are asked to physically move around while listening to upbeat music, such as children's music or pop music. The physical activity may be, for example, running in place, dancing, skipping, jumping jacks or the like. When the students are not familiar with a specific word, the instructors may first read and repeat the word and then ask the students to repeat the same.

The students remain in Room 1 for approximately eight to ten minutes while working on sight words, phonemic awareness, phonemic blending, syllable awareness, syllable blending, rhyming, fluency and apply that knowledge to learn and comprehended nouns, verbs, prepositions, pronouns, adjectives, plurals and tenses. It is desirable to keep the students in Room 1 for this length of time as it has been demonstrated to be long enough to learn material while not being too long where the students may begin to become bored with the program or otherwise easily distracted.

Within the interior of Room 1, kinesthetic learning is utilized. Further, in Room 1, a computer monitor may be located on a wall wherein the monitor displays educational material. Aside from the computer monitor, the room is preferably substantially empty; lacking any furniture. The lack of furniture and other objects has been demonstrated to increase the student's focus on the learning program. As stated above, upon entering Room 1, the students are instructed to immediately engage in physical activity, such as dancing, jumping, skipping, etc.

More specific examples of the physical activities include: I) Limbo-Students say one to three target words/phrases then go under the pole. After the first round, the pole is lowered. If a student touches the pole, they are out for that game. II) London Bridges—Two students make a bridge with their hands. Students say one to three target words/phrases then go under the bridge. If the bridge falls, then the student says another one to three target words/phrases. III) Hot Potato-Using a ball or balloon, students pass the ball or balloon quickly to each other while saying the target words/phrases. If the student drops the ball or the balloon, then they are out of the game. IV) Jumps-Using blue painters tape make “X”'s or shapes (circles, squares, triangles) on the floor. Students jump from marker to marker while saying the target words/phrases in unison. The jump markers can be placed in a circle, square or zig-zag for jumping. A challenge jump may be placed for reentry into the game or extra points to be jumped after reading challenge words/phrases or extra target words/phrases. V) Character Reading—The students line up in a single line. They take turns stepping up to read one to three target words/phrases in their favorite character voices. VI) Basketball Reading—The students line up in a single line. Each student takes turns stepping up to the free throw line and reads 1 to 3 target words/phrases. The number of shots they get to take toward their points is determined by how many words/phrases they said correctly at the free throw line. VII) Line Dancing-Students say target words/phrases in unison with each step. Example: Step right, step together, step left, step together, step back, step together, step forward, step together completes a cycle and represents eight target words/phrases. This series is used for early learners. Traditional line dances can be used as well. Short motor sequences that can be easily memorized and easily repeated in the same sequence are most effective. VIII) Word Tag (Similar to Duck, Duck, Goose)—Students sit in a circle. One student says the target words/phrases while tapping the heads of the remaining students that are sitting in the circle. Once the student saying the target words/phrases taps the head of another student and says “tag”; the “tagged” student chases the first student around the circle. If the tagged student catches the first student then the first student continues to be “it”. If the tagged student doesn't catch the first student, then the tagged student begins saying the target words/phrases and selects another “tagged” student.

The physical activity enhances the student's ability to learn to read as a result of pairing new reading skills with gross motor movement. This is thought to be accomplished as a result of the neuron-motor activity of the body connecting with cognitive learning in the brain. While engaging in the physical activity, the students actively read words out loud. In one version, the students read the words out loud individually. In an alternative embodiment of the method, a plurality of students read the words out together as a single unit. After the students finish the steps in Room 1, the students immediately move to Room 2.

As stated above, after the students perform the tasks of Room 1 for eight to ten minutes straight, the students immediately move to Room 2 (in an embodiment, the students move to Room 2 from Room 1 in less than one minute). In Room 2 (sometimes called the “iPad® Room”) the students write and illustrate stories which are of personal high-interest to them. Upon entering Room 2, the students first settle on the floor; preferably in a sitting position. The students then utilize a computer (such as an iPad®, a tablet or other device) to create a story of their choosing. For example, a student may create a story about his or her pet. The instructor(s) then help the students by incorporating the students input into the story. In an embodiment, the students and instructor both incorporate story mapping, character development, sequencing, problem solving, spelling, grammar and reading comprehension into the story. In example of story mapping could be, for example, naming a story character and then placing the story character into a setting such as the playground at school on a designated page number. Next an event may be described which is associated with that named character in that setting on that page. This same sequence may be continued for each character, setting and event formulating a beginning, middle and end (conclusion) representing a completed version of a story that is ready for publication. Students may be then asked to write simple complete sentences using proper spelling, plot and character development. Upon completion of the tasks in Room 2, the students are then immediately moved to Room 3. In an embodiment, the students move to Room 3 from Room 2 in less than one minute. In an embodiment, at the end of the nine week session system, the student's stories may be printed out for them to take home wherein they may continue to practice reading. The students remain in Room 2 for approximately twenty to twenty-five minutes before moving to Room 3.

In Room 3 (the “manipulative room”) the students may use blocks, play-dough, cards and other games to segment and blend sounds, syllables, phrases and sentences for approximately fifteen to twenty minutes. The students are given these articles to manipulate while learning word and sound skills. Retention and application of the new skills through sight, hearing and touch is therein developed. Proper spelling and syllabilzation of sight words, vocabulary may be facilitated through the hands-on activities with the articles. Phoneme awareness strengthened through phoneme segmenting and blending is thus accomplished. Further, in Room 3, the students dissect the English language then put it back together again. For example, letters may be dissected from words and analyzed for sounds represented as well as placement of that sound in sequence with the other letters. Syllables may be dissected from words and analyzed for connected sounds as well as placement with other syllables. This process may continue at the phrase and sentence level as well. This is the analytical process of segmentation and blending at the sound, syllable, phrase and sentence levels taught to the students as a tool for functional reading. After completing Room 3, the students move immediately to Room 4, the final room. Preferably, the students move to Room 4 from Room 3 in less than one minute.

More specifically, in Room 3 the students may manipulate objects by using, for example, blocks in a stacking game (to represent letter sequences, syllable sequences or word sequences. This can be used to segment or blend sounds, syllables or words/phrases). Students may also build a sentence tower; build a word tower; build a bridge. Students may also use play dough to make a word, make an object, make a letter and form sentence structures.

In Room 4 (sometimes called the “video review room”) the students spend the last five to eight minutes of the rotation again reviewing the reading of the most common frequently used words applied to phrases and rhymes infused with dynamic words from the instructions to upbeat music. In an embodiment, the words in the 4^{th} room are the same as the words in the 1^{st} room; therein reinforcing the words. The students work on skill review and application using sight words infusing dynamic high interest words (as described above) with fluency for increased comprehension. The students review words, phrases, rhymes, nouns, verbs, prepositions, adjectives, adverbs, plurals, prefixes and suffixes as presented while moving to music to reinforce and facilitate kinesthetic learning. This room (Room 4) is preferably loud and provides active participation. At the end of this final step, the student may re-enter Room 1 and repeat the process two times per week, for nine weeks; preferably after a brief break of one to three days to relax from the method.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1) A method of teaching comprising the steps of:
providing a plurality of rooms;
introducing a plurality of students into a first room of the plurality of rooms;
providing a single electronic monitor in the first room;
instructing the plurality of students to immediately engage in physical activity such as jumping jacks, jumping, dancing or skipping;
displaying a word on the electronic monitor while the plurality of students engaging in the physical activity;
instructing the plurality of students how to pronounce the word on the electronic monitor;
instructing the plurality of students to repeat the word pronounced to them; and
instructing the plurality of students to leave the first room and enter a second room of the plurality of rooms.

2) The method of teaching of claim 1 wherein the first room is substantially empty aside from the electronic display.

3) The method of teaching of claim 1 wherein the plurality of students engage in the physical activity for eight to ten minutes.

4) The method of teaching of claim 1 further comprising the steps of:
providing a substantially empty second room;
providing each of the plurality of students with a movable personal computer having an electronic display;
instructing the plurality of students to write stories related to subjects of their interest; and
wherein the students write the stories on the movable personal computer.

5) The method of teaching of claim 4 further comprising the step of:
instructing the students to illustrate their stories.

6) The method of teaching of claim 4 further comprising the steps of:
providing a third room;
providing the plurality of students with objects to be manipulated such as blocks, play-dough, cards or the like; and
instructing the plurality of students to manipulate the objects while spelling a word provided to them.

7) The method of teaching of claim 6 further comprising the steps of:
providing a fourth room; and
instructing the plurality of students to repeat the words learned in the first room for approximately five to eight minutes.

8) The method of teaching of claim 7 further comprising the steps of:
instructing the plurality of students to reenter the first room; and
instructing the plurality of students to read the words learned in the first room.

9) The method of teaching of claim 1 wherein the rooms are brightly colored.

10) The method of teaching of claim 1 wherein the students move from the first room to the second room in under one minute.

11) The method of teaching of claim 4 further comprising the steps of:
printing out the stories created by each student; and
providing the plurality of students with the stories created by them so that the plurality of students continue to read the stories and the learning is reinforced.

12) The method of teaching of claim 7 wherein the entire rotation of moving the plurality of students from room one to room two, to room three, to room four and then back to room one takes place in a single day.

13) The method of teaching of claim 12 wherein the entire rotation takes place each day for nine weeks.
